(19) United States
(12) Patent Application Publication
(10) Pub. No.: US 2008/0133132 A1
(43) Pub. Date: Jun. 5, 2008

(54) Method For Displaying Map Information

(76) Inventors: Thomas Jung, Bielefeld (DE); Michael Bruenig, Queensland (AU); Lothar-Frank Smirnov, Stuttgart (DE)

Correspondence Address: KENYON & KENYON LLP, ONE BROADWAY, NEW YORK, NY, 10004, US

(21) Appl. No.: 11/659,623

(22) PCT Filed: Jun. 14, 2005
(86) PCT No.: PCT/EP05/52742

§ 371 Date: Dec. 2, 2007

(30) Foreign Application Priority Data
Aug. 10, 2004 (DE) 102004038740.0

(51) Int. Cl. G01C 21/32; G09B 29/00

(52) U.S. Cl. 701/212; 701/208

(57) ABSTRACT

A method for displaying map information for a navigation system in which the map information includes areas representing a top view of a map detail, and lines representing a grid of traffic routes. In order to improve the display of the area information using additional background information, the display of the areas in a two-dimensional or three-dimensional view is at least partially generated on the basis of aerial and/or satellite images and the resolution of the aerial and/or satellite images is varied as a function of the density of the displayed grid of traffic routes.

### FIELD OF THE INVENTION

The present invention relates to a method for displaying map information for a navigation system in which the map information includes areas representing a top view of a map detail, and lines representing a grid of traffic routes. Furthermore, the present invention relates to a navigation system for executing the method according to the present invention.

### BACKGROUND INFORMATION

Navigation systems have been widely used in previous years, in particular in mobile use in motor vehicles. The basic functions “location finding,” “destination selection,” “route computation,” and “destination guidance” are implemented in the known systems. A digital map of the road network is required for all functions, the digital map typically being placed and stored on a CD-ROM, a DVD, or an HD.

In addition, the display is possible preferably as a colored map. Depending on the system, display of the map on a color monitor may take place over a scale range of approximately 1:8,000 to 1:16,000,000. This display is helpful in order to obtain an overview of the route in the nearer and farther surroundings, depending on the scale. The orientation is facilitated by topographic information, e.g., built-up areas, bodies of water, forests, and railroad lines.

In current navigation systems having a map display, the information is displayed in the form of a vector map on a color monitor. The vectorization makes possible the change of the display scale based on the same underlying stored data.

In this map display, the total information is composed of areas, lines, and dots. The region to be displayed is characterized by different coloring of the areas. A built-up area, i.e., a town, is often colored red. Bodies of water are indicated by blue areas and fields and forests are indicated by different shades of green. Lines of different thickness and color are used in the display to indicate different roads, railroad lines, or rivers. Individual dots or icons are inserted into the overall map display as a further layout element for POI (point of interest), e.g., gas stations, repair shops, hotels, etc.

The area display is heavily simplified and hence very abstract. Especially in a display with higher resolution, i.e., in particular of the nearer surroundings, additional information which would facilitate the orientation of the user is unobtainable from the display.

It is therefore an object of the present invention to improve the display of the area information in maps for navigation systems by providing additional background information.

### SUMMARY OF THE INVENTION

According to the present invention, this object is achieved by generating the area display in a two-dimensional or three-dimensional view at least partially based on aerial and/or satellite images and by varying the resolution of the aerial and/or satellite images as a function of the density of the displayed grid of traffic routes. This additionally structured background information of the images, e.g., building contours and plantings, help the user to translate the information of the map into reality, thereby clearly facilitating his/her orientation. The three-dimensional view makes a perspective display possible.

The quantity of required map data is substantially increased due to the use of aerial and/or satellite images as background information in a monitor navigation system. The required data quantity may be significantly reduced by including the density of the displayed road network as a structural parameter for the resolution of the used images. Detail-rich images having more background information are used in areas having a high road density, e.g., in metropolitan areas. In contrast, images having a lower resolution and thus a smaller information quantity are used for the display in areas which are hardly populated, e.g., in rural areas. This makes a sufficiently informative display of the map possible using a manageable data quantity.

A preferred embodiment of the method according to the present invention provides that the resolution of the aerial and/or satellite images is varied as a function of the map detail to be displayed. This makes it possible to adapt the accuracy of the display according to the situation.

In an advantageous refinement of the method according to the present invention, the resolution of the aerial and/or satellite images is varied as a function of the average population figure per area. This structural parameter takes into account the fact that the population density in built-up areas, e.g., cities, is distinctly higher than in rural areas.

The average number of buildings per area is taken into account as a further advantageous structural parameter. In principle, this structural parameter is similar to the previous structural parameter in which the population figure is taken into account; however, the number of buildings per area is directly obtainable from the aerial and/or satellite image without having to use other sources, e.g., statistics of the registry offices.

A navigation system for executing the method according to the present invention has a memory device for map information data, a processor device which processes the map information data, and a display device which outputs the processed map information data. As map information data, the vectorized road network as well as the image data from aerial and/or satellite images are stored in the memory device as area information data. The memory device may be used arbitrarily, i.e., any optical and/or magnetic memory device may be used for implementation. The processor device merges the different map information data in such a way that a uniform display including areas, lines, and dots is generated which is subsequently output on the display device, e.g., a color monitor.

In a preferred navigation system according to the present invention, the memory device has a CD (compact disc) and/or a DVD (digital versatile disc). Furthermore, storage on HD or any memory components is conceivable. This makes simple updates of the existing data and/or exchange for application in another state or country possible.

The memory device of a navigation system according to the present invention preferably includes image data from aerial and/or satellite images having different resolutions. This makes a variably accurate display possible depending on the importance of the particular area.

### BRIEF DESCRIPTION OF THE DRAWINGS

FIG. 1 shows a schematic outline of a navigation system for executing the method according to the present invention.

FIG. 2 shows a typical map display for a navigation system.

FIG. 3 shows a detail of an aerial and/or satellite image.

FIG. 4 shows a map display for a navigation system generated using the method according to the present invention.

### DETAILED DESCRIPTION

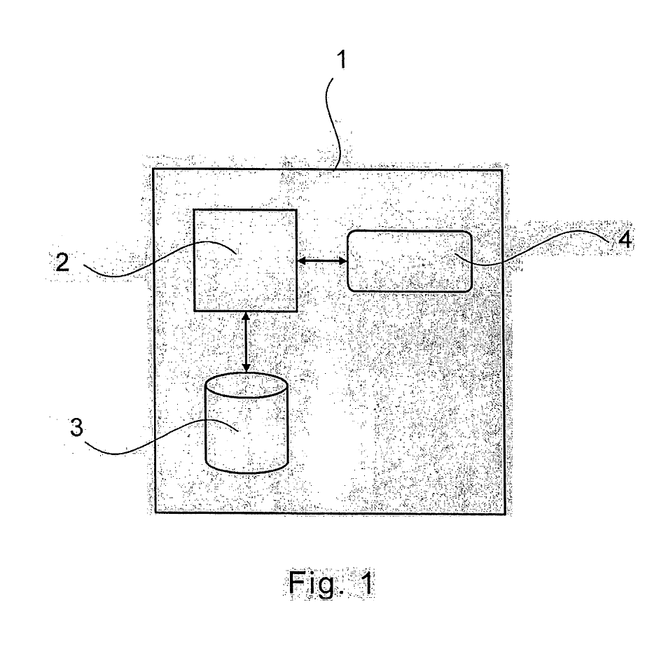

FIG. 1 schematically shows a navigation system 1 including a processor device 2. Processor device 2 is connected to a memory device 3 and processes the map information stored in memory device 3. The map display generated by processor device 2, e.g., a superimposition of the vectorized map of the road network with aerial and/or satellite images, is subsequently output on display device 4, e.g., a color monitor.

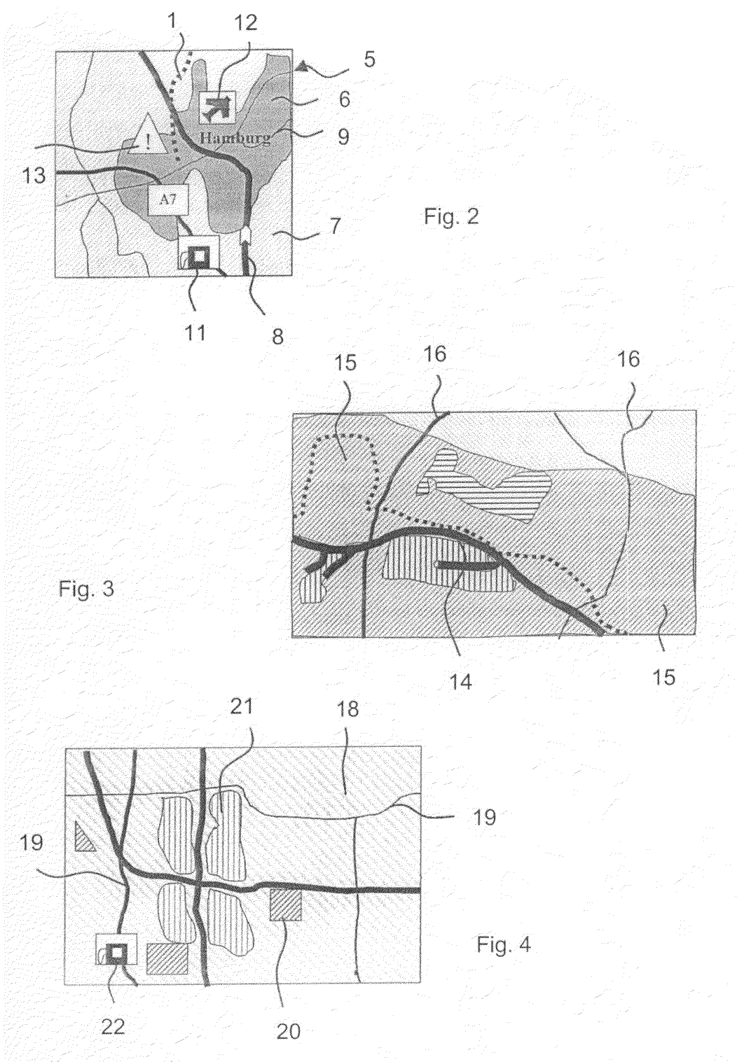

The method according to the present invention is described in greater detail in the following. A map detail 5 showing a subarea of a metropolitan area., Greater Hamburg in the present example, is represented in FIG. 2. The area information is essentially differentiated by two different colors. The darker area 6 indicates a built-up area. The lighter area 7 indicates essentially natural areas, in particular fields and forests.

Furthermore, different lines 8, 9, and 10 which indicate the road network are shown in the figure. Road 8, more clearly highlighted in terms of color, is a freeway (German Autobahn), while the road indicated by reference numeral 9 is a less expansive road, e.g., a rural road or an inner-city arterial road. Line 10, displayed in two alternating colors, shows the path of a railroad line or a railroad track.

Furthermore, additional image points or icons for indicating POIs (point of interest) exist in the display of map detail 5. Reference numeral 11 marks an icon for displaying the location of a gas station. Icon 12 indicates the position of the airport and icon, 13 indicates the location of a traffic obstruction or a traffic jam.

FIG. 3 shows an aerial and/or satellite image of the inner city. The course of a river 14 as well as densely populated areas 15 are shown in FIG. 3. FIG. 3 also shows the path of roads 16 of different types and sizes.

FIG. 4 shows a map detail 17 generated using the method according to the present invention. Data of an aerial and/or satellite image is added to map detail 17 as background data. The vectorized road network is superimposed on this background image as more detailed information in such a way that ;a freeway (autobahn) 18 and additional roads 19 are clearly visible in map detail 17.

Not only a monotone area is shown between individual roads 18, 19, but also the real structure of the respective area. The user also sees in the display of the navigation system whether a building 20 or a park 21 is located adjacent to the road.

Finally, additional particular POIs are indicated using image points or icons 22. The particular image section, e.g., the outline of a public building, is transparently colored. The building stands out from the displayed surroundings and is easier to identify.

A substantial increase in map data in navigation system 1 (FIG. 1) results when the structured background information is generated via aerial and/or satellite images. Image information having varying degrees of high resolution must be provided for different display scales. The following Table 1 lists the data quantities for Germany with an area of approximately 876 km by 632 km.

TABLE 1

| | Resolution | Resolution | Resolution | Resolution |
|---|---|---|---|---|
| Area | 1 million | 5 million | 20 million | 100 million |
| 375,000 km² | 140 GB | 6 GB | 350 MB | 14 MB |

The data quantities cited above refer to a compressed data format. These specifications are an example and are only used to provide a rough orientation and, in addition, may vary as a function of the used compression algorithm.

This data clearly shows that at a high resolution, e.g., 1 million per pixel, the total data quantity is no longer able to be stored on standard memory media such as CDs or DVDs. Particularly at smaller display scales (50 m-5 km), a reduction in the resolution results in an unsightly, non-acceptable display. Only a resolution of 10 million per pixel would be able to be used area-wide, if the same resolution is selected for the entire German federal territory.

According to the present invention, the resolution for different areas is selected as a function of their importance. The road network density is used as a structural parameter for evaluating the importance. If this structural parameter is included in focused partitioning of the resolutions, more detailed image information is used in areas with a high road network density. In contrast, only data having a coarser resolution is used in primarily rural areas which hardly have any roads and thus offer little orientation-relevant information. Due to this fact, the data volume of the stored image data may be distinctly reduced, while maintaining a constant viewing quality. The resulting memory capacity for the image display is then of a magnitude which may be stored on standard memory media, such as CDs. In order to optimally utilize the memory capacity of the memory medium, the evaluation of the road network density may be varied by using a memory medium having a larger memory capacity, such as a DVD.

In addition to the structural parameter road density, population density and/or the development density of the respective areas may be used as evaluation criteria.

Using the development density as a structural criterion has the advantage that the information exists on the underlying aerial and/or satellite images themselves. An additional data source, e.g., statistics of the registry offices, is not necessary. Of course, a combination of all three structural parameters may be used as a meaningful evaluation scale.

1-8. (canceled)

9. A method for displaying map information for a navigation system in which the map information includes areas representing a top view of a map detail, and lines representing a grid of traffic routes, the method comprising:
generating a display of the areas in one of a two-dimensional and three-dimensional view at least partially based on at least one of aerial and satellite images; and
varying a resolution of at least one of the aerial and satellite images as a function of a density of the displayed grid of traffic routes.

10. The method according to claim 9, wherein the resolution is varied as a function of the map detail to be displayed.

11. The method according to claim 9, wherein the resolution is varied as a function of an average population figure per area.

12. The method according to claim 9, wherein the resolution is varied as a function of an average number of buildings per area.

13. The method according to claim 9, further comprising marking at least one waypoint in the map information by an image element.

14. A navigation system comprising:
a memory device for storing map information;
a processor for processing the map information; and
a display device for displaying the processed map information,
wherein the memory device, processor and display device cooperate to perform a method for displaying the map information in which the map information includes areas representing a top view of a map detail, and lines representing a grid of traffic routes, the method including:
generating a display of the areas in one of a two-dimensional and three-dimensional view at least partially based on at least one of aerial and satellite images, and
varying a resolution of at least one of the aerial and satellite images as a function of a density of the displayed grid of traffic routes.

15. The navigation system according to claim 14, wherein the memory device includes at least one of a compact disc and a digital versatile disc.

16. The navigation system according to claim 14, wherein the memory device stores image data of at least one of aerial and satellite images having different resolutions.
